(19) United States
(12) Patent Application Publication
(10) Pub. No.: US 2006/0031087 A1
(43) Pub. Date: Feb. 9, 2006

(54) Mentor-protege matching system and method

(76) Inventors: Stephanie J. Fox, Oakland, CA (US); Carol B. Muller, Palo Alto, CA (US)

Correspondence Address: DLA PIPER RUDNICK GRAY CARY US LLP, 153 TOWNSEND STREET, SUITE 800, SAN FRANCISCO, CA, 94107-1907, US

(21) Appl. No.: 11/197,762

(22) Filed: Aug. 3, 2005

Related U.S. Application Data
(60) Provisional application No. 60/598,907, filed on Aug. 3, 2004.

(51) Int. Cl. G06Q 99/00; G06F 15/02

(52) U.S. Cl. 705/1; 705/9

(57) ABSTRACT

A computer-implemented method for bi-directionally matching a protégé and a mentor among participants in an online environment includes registering the protégé so that he or she can be uniquely identified within the online environment. A mentor profile is received including demographic and/or personal information about the mentor, as well as the mentor's preferences regarding potential protégés. A protégé profile is also received including demographic and/or personal information about the protégé, as well as the protégé's preferences regarding potential mentors. One or more recommended mentor-protégé matches are bi-directionally calculated based on the information and preferences. One or more coaching prompts and evaluation requests are sent to matched participants.

This application claims the benefit of priority to U.S. provisional patent application Ser. No. 60/598,907, filed Aug. 3, 2004, which is hereby incorporated by reference.

### BACKGROUND

1. Field of the Invention

The present invention relates to a person-to-person matching and coaching system, and particularly to matching mentors and protégés in an online environment that may be large scale involving a variable number of potential mentors and potential protégés.

2. Description of the Related Art

In an online mentor-protégé matching environment, mentors and protégés can be geographically located anywhere. It is desired to create a successful, scalable, global online e-mentoring program that can handle a large number of matches, make the best possible matches, provide the program facilitation, including regular coaching, maintain a high quality of customer service, and is relatively automated such as to utilize a relatively small amount of human resources.

Systems for matching mentors and protégés that currently exist include on-campus programs, manual matching programs, programs that do not provide coaching or facilitation, or that rely on manual coaching. These programs also do not allow for bi-directional matching, using the profiles and match preferences of both the mentors and protégés. Also, programs where protégés are required to choose mentors themselves are not adequate.

Most person-to-person matching systems are uni-directional. One group of people provides descriptions of themselves. Then, a person looking to match with one or more of the people in the group provides one or more preferences, and the system provides a match of the preferences with a closest description. It is desired to have a more flexible matching system that works in a bidirectional manner to match mentors and protégés based on demographics, preferences and personal information of each of the potential mentors and protégés. Furthermore, for mentoring relationships to be more satisfying and productive within a structured mentoring program, it is desired to have a system that effectively provides for ongoing communications and “coaching” between mentors and proteges.

### SUMMARY OF THE INVENTION

A computer-implemented method for bi-directionally matching a protégé and a mentor in an online environment includes registering the protégé so that he or she can be uniquely identified within the online environment. At least one mentor profile is received including demographic and/or personal information about the mentor, as well as the mentor's preferences regarding potential protégés. A protégé profile is also received including demographic and/or personal information about the protégé, as well as the protégé's preferences regarding potential mentors. One or more recommended mentor-protégé matches are bi-directionally calculated based on the information and preferences.

The bi-directional calculating may include comparing information and preferences of multiple pairs of mentor-student profiles. The bi-directional calculating may further include (i) computing a percentage for each area based on how closely the areas match; (ii) summing to obtain a total match score; and (iii) determining that the total match score is above a predetermined match score. The bi-directional calculating may further include (iv) setting a weight to one or more information or preference areas within the mentor or student profiles, or combinations thereof; and (v) multiplying the percentage by the weight provided to each area.

The demographic information may include race, age, location, gender, ethnicity or citizenship, or combinations thereof. The personal information may include education, employment, a personal statement or a reference contact, or combinations thereof. The preferences may include gender, degree, alma mater, employer, work sector, location or ethnicity, or combinations thereof.

A server-based computer system for bi-directionally matching a protégé and a mentor in an online environment is also provided. A main web site for registering the protégé from a first remote client computer is connected to the server by a network connection, so that he or she can be uniquely identified within the online environment. A database server for receiving a mentor profile from a second remote client computer is also connected to the server by a network connection. The mentor profile includes demographic and/or personal information about the mentor, as well as the mentor's preferences regarding potential protégés. The database server also receives a protégé profile from the first or a third network-connected remote client computer including demographic and/or personal information about the protégé, as well as the protégé's preferences regarding potential mentors. One or more processors bi-directionally calculate one or more recommended mentor-protégé matches based on the information and preferences, and outputs results.

One or more processor readable storage devices are also provided having processor readable code embodied thereon. The processor readable code programs one or more processors to perform any of the recited bidirectional calculation methods.

### BRIEF DESCRIPTION OF THE DRAWINGS

FIG. 1 is a flow chart illustrating a process for matching a protégé and a mentor in accordance with a preferred embodiment.

FIG. 2 is a flow chart illustrating a process of obtaining a protégé profile in accordance with a preferred embodiment.

FIG. 3 is a flow chart illustrating a process of obtaining a mentor profile in accordance with a preferred embodiment.

FIG. 4 is a flow chart illustrating a process of scoring possible mentor-protégé matches based on the information obtained according to the flow charts at FIG. 2 and 3. FIG. 5 schematically illustrated a computer system for implementing the processes of FIGS. 1-4 in accordance with a preferred embodiment.

FIGS. 6a-6m are exemplary web pages for obtaining protégé input in accordance with a preferred embodiment.

FIGS. 7a-7m are exemplary web pages for obtaining mentor input in accordance with a preferred embodiment.

### DETAILED DESCRIPTION OF THE PREFERRED EMBODIMENTS

The preferred embodiment includes a complete system for two groups of people to use as a complete e-mentoring tool. The system allows for bi-directional matching, as well as automated, self-running e-mentoring. This preferably includes the ability to begin a match any day of the year, as well as automated custom emailed coaching prompts throughout the relationship. The system can allow administrators of the program a way to setup automated coaching prompts. The system further allows the main groups (sponsors) access to live information about each participating mentor/student.

A system in accordance with a preferred embodiment, hereinafter referred to in places as “MentorNet”, pairs undergraduate and graduate students and early career professionals with female or male professionals working in industry or government agencies and laboratories, or higher education for eight-month-long, structured one-on-one mentoring relationships conducted via email. Designated MentorNet liaisons within colleges and universities, corporations, government sites and professional societies inform professionals and students of the opportunity to participate in the MentorNet program, directing them to the MentorNet web site. Prospective participants get full information, complete online applications, and access training materials including tutorials from MentorNet's web site. MentorNet has developed and refined software programs and related systems to conduct bi-directional matching of students and mentors based on backgrounds, interests, and expressed preferences entered into a database via the online applications. MentorNet's customized training and coaching curricula are automatically sent to the participants via email as they are matched, and are sent at regular (weekly or bi-weekly, depending upon the student's level of study) intervals during the eight month relationship. These curricula are based on research related to mentoring, women's experiences in engineering and science, and electronic communications. Mentoring relationships last for eight months at a time, and as part of the coaching curriculum, all participants are asked to complete online evaluations at the end of the relationships. Part of the data from the evaluations are then made available on the web site for viewing (without identifiers) by the organizational constituent of the student or mentor. Distinctions are preferably made in providing coaching and training materials based on five possible educational levels of the students involved, as follows—1) community college students, 2) first or second year undergraduates (lower division), 3) 3rd, 4th, or 5th year undergraduates (upper division), 4) masters students, and 5) doctoral students. A sixth level may include early career professionals. There may be additional protégé classes including any individual or group that could benefit from a relationship with a mentor. Different distinctions can be made or the system can be operated without applying any distinctions. To complement and enhance the One-on-One e-mentoring program, MentorNet also offers a community experience to its participants including such features as a monthly electronic newsletter and a series of online topic-based discussion groups focused on life/work balance, women's issues, job search, and similar themes. MentorNet's online community members may participate in these functions alone and/or in the One-on-One Mentoring Program.

### Recruiting

MentorNet recruits participants primarily through liaisons within its 80-plus participating colleges and universities, 12 corporations, 6 government labs and agencies, and 2 professional societies, as well as through collaborative relationships with organizations such as the Association for Women in Science (AWIS), Society of Women Engineers (SWE), the Women in Engineering Programs & Advocates Network (WEPAN), and others, providing a strong foundation for reaching potential protégés and mentors.

### Applications and Matching

Interested students and prospective mentors complete an application online. Data about participants' area of technical interest or major field of study, industrial sector, vocational interest, gender, ethnicity, are collected and a computer-based sorting program identifies the most suitable potential mentors for a student.

### Training

MentorNet provides training for both mentors and protégés, so that both, as fully participating adults, can work together and take mutual responsibility for the success and value of their relationship. MentorNet's training curriculum prepares mentors and protégés for the mentoring process. Research has shown that people can become effective mentors through training. A goal of the training program is to expand and encourage synergy within protégé-mentor pairs, making the mentoring relationship as effective as possible, and to add to participants' knowledge of issues for women in engineering and science, based on research and findings.

### Coaching

Once matched, mentors and protégés are expected to communicate on a regular basis, typically weekly or bi-weekly. In addition, mentoring pairs are encouraged, where feasible, to supplement their email interactions with phone conversations and face-to-face visits. Pairs are committed to a relationship for eight months; following that period of time, participants may continue to maintain the relationship for eight month cycle, find a new partner, or leave the program.

MentorNet provides on-going support and communications to the e-mentoring pairs through “coaching prompts”—email from MentorNet's program managers containing discussion suggestions, preferably delivered periodically such as approximately every two weeks. These discussion suggestions constitute the coaching “curriculum” for MentorNet and serve a coaching function along four dimensions. First, they keep the lines of communication open between the MentorNet program staff and participants. At the end of each discussion suggestion MentorNet solicits responses from the participants if they are not in contact with their e-mentoring partner, if they are uncomfortable with any of the e-mentoring interactions, or if they have any questions or comments. Second, the discussion suggestions help MentorNet to “coach” the e-mentoring pairs through the stages of a mentoring relationship. Early messages suggest that each pair agrees to an informal “mentoring contract” that lays out the frequency of the communication and their personal goals for the program. The final coaching messages prompt participants to reflect on their experiences and bring the program to a close. Third, the discussion suggestions are a means to educate mentors and the protégés about issues pertinent to women in engineering and science. Fourth, the suggestions serve as a reminder to keep in contact with their e-mentoring partner. In addition to the regularly delivered discussion suggestions, the participants are sent monthly newsletters updating them on the activities of the MentorNet program.

### Matching System Illustrations

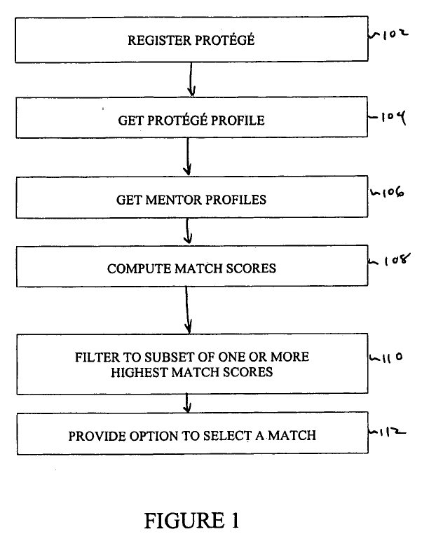

FIG. 1 provides a general workflow for a method in accordance with a preferred embodiment. Referring to FIG. 1, to begin the process at component 102, protégés register to participate in the program by going to the main web site and entering a unique usemame, choosing a password, and entering their email address, and their first name and last name. This information is automatically downloaded into the database, and each person is automatically given a unique ID, which is an integer value that is used to uniquely identify each person in the database and throughout the web site. Although not shown, preferably mentors also register.

Once the registration is complete, each protégé completes a corresponding ‘Protégé Profile’, which may include demographic information (age,gender,race/ethnicity,citizenship), educational information ( . . . ), a personal statement, a rating of 10 topics (from 0-4) that they might like to discuss with their mentor, and their preferences for being matched with a mentor. t

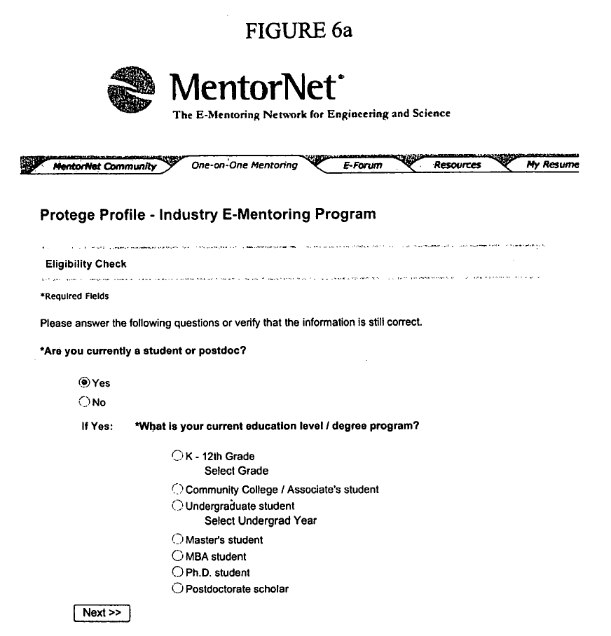

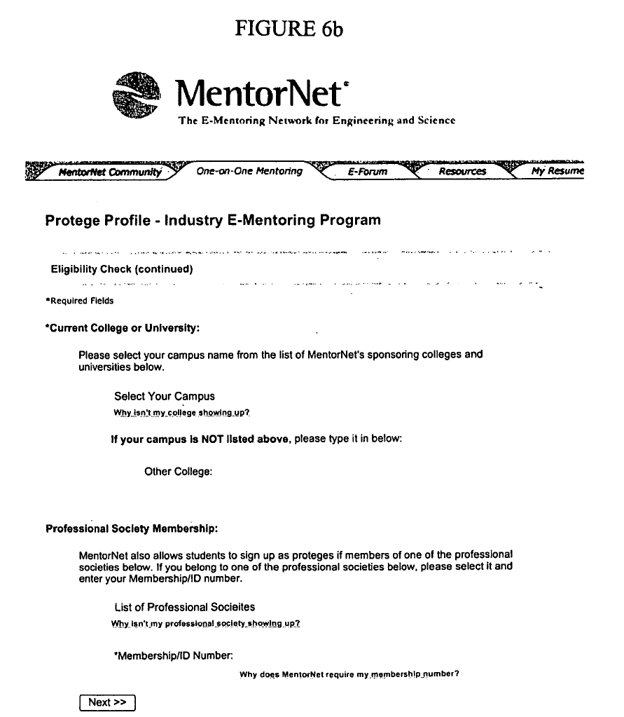

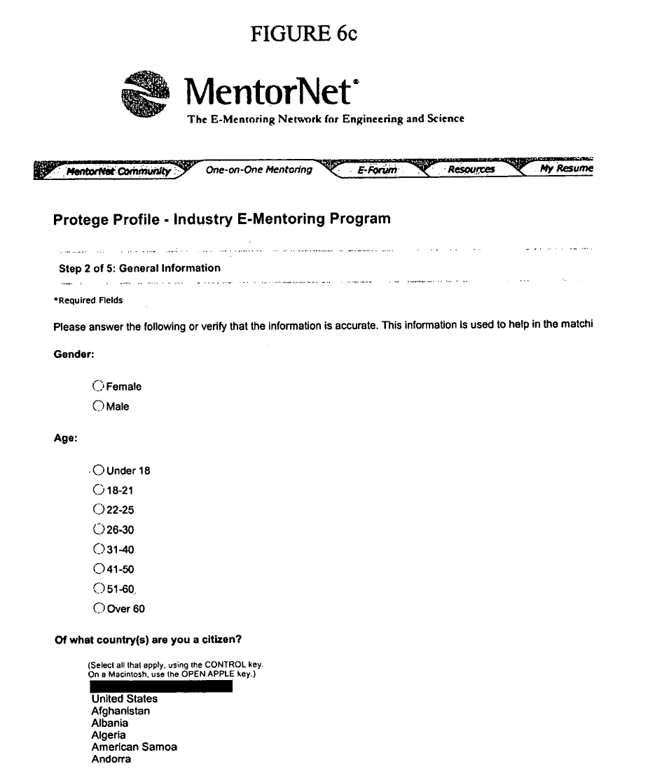

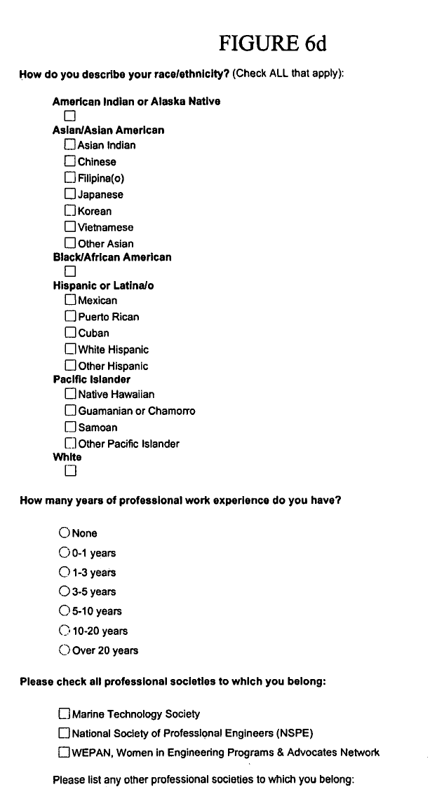

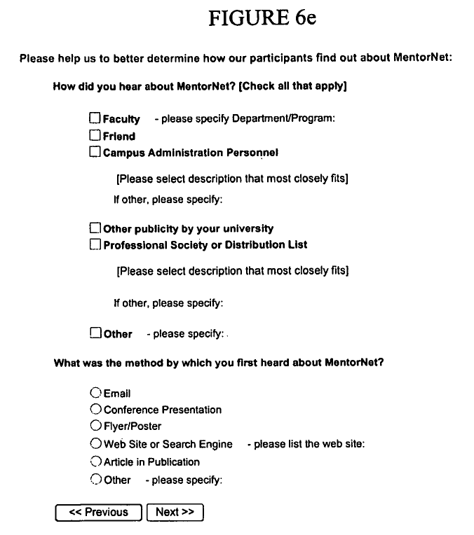

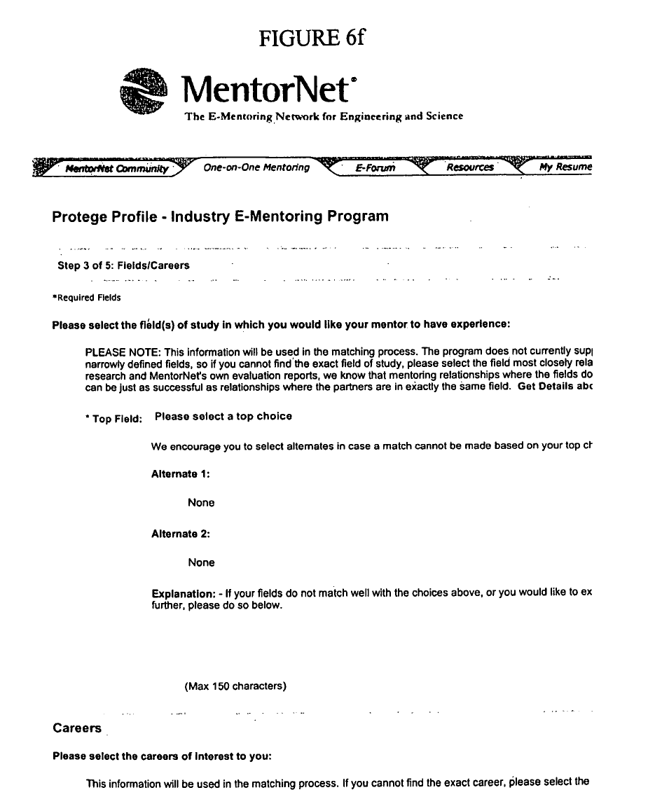

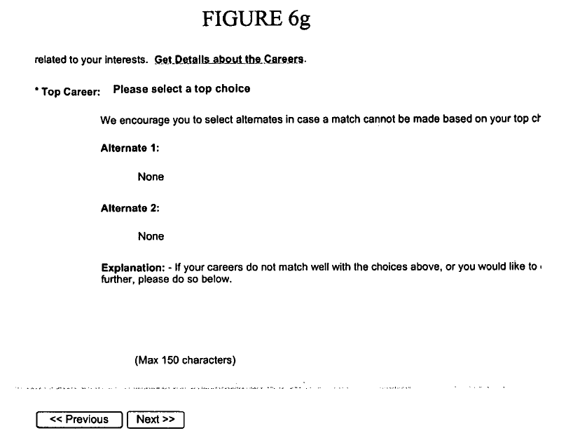

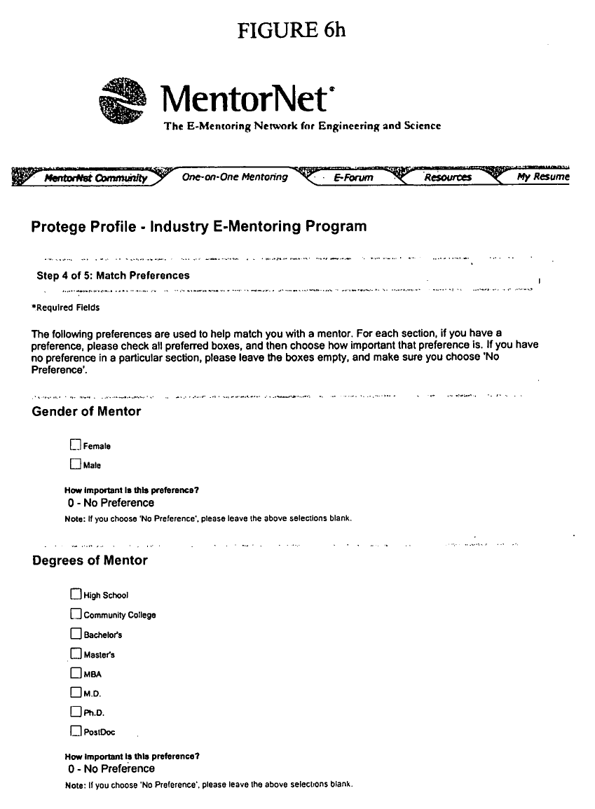

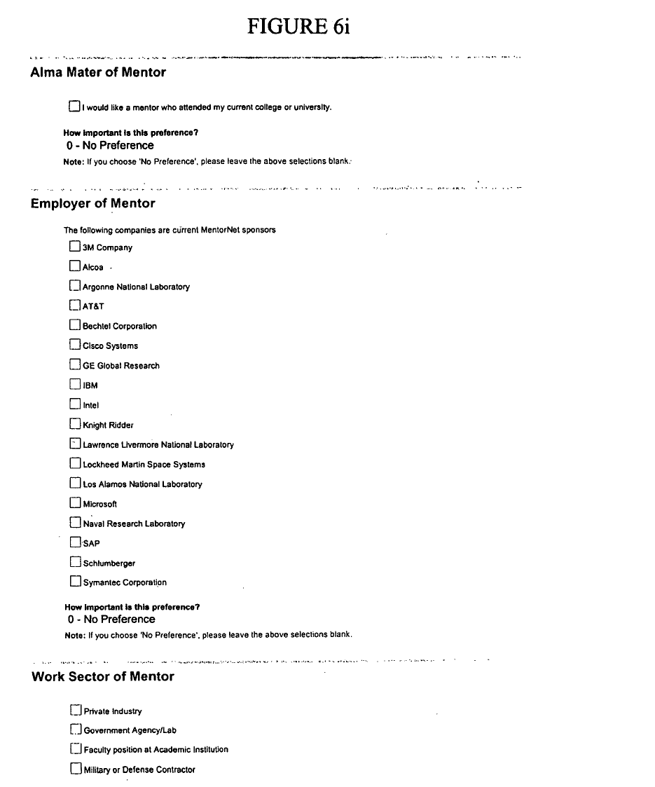

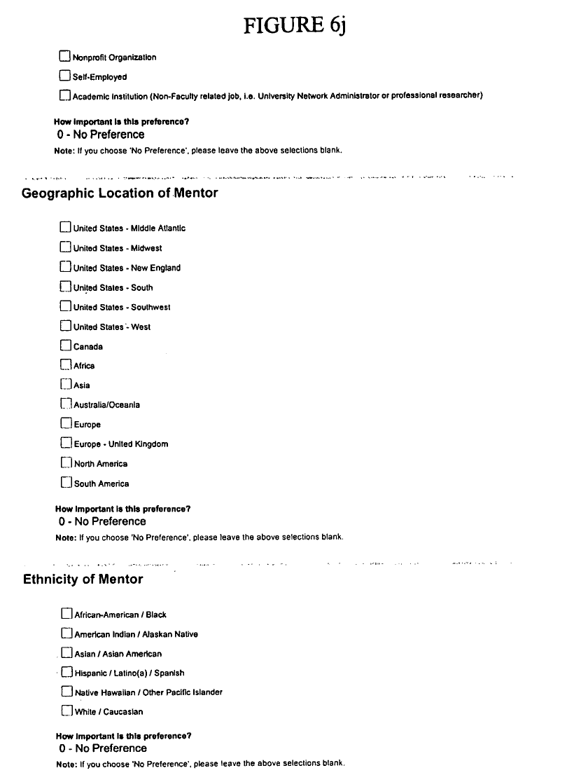

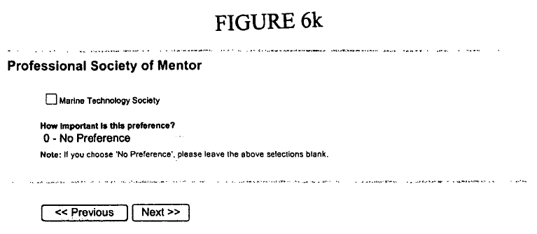

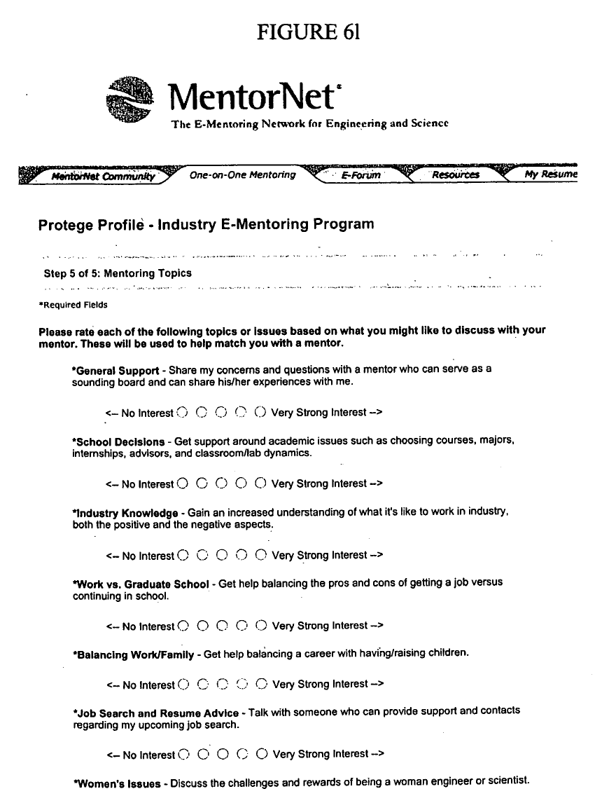

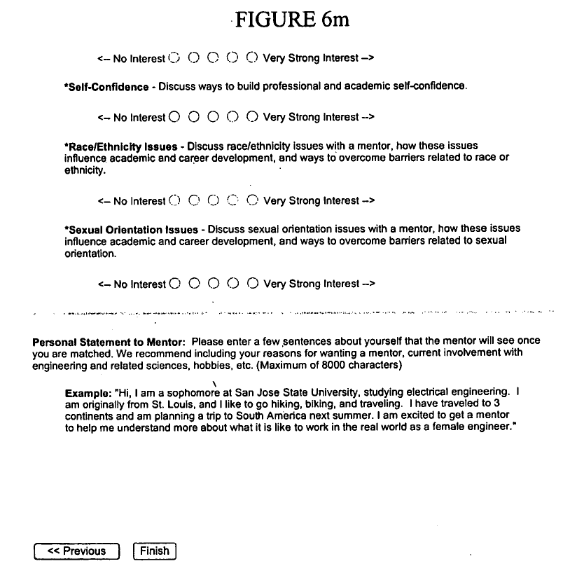

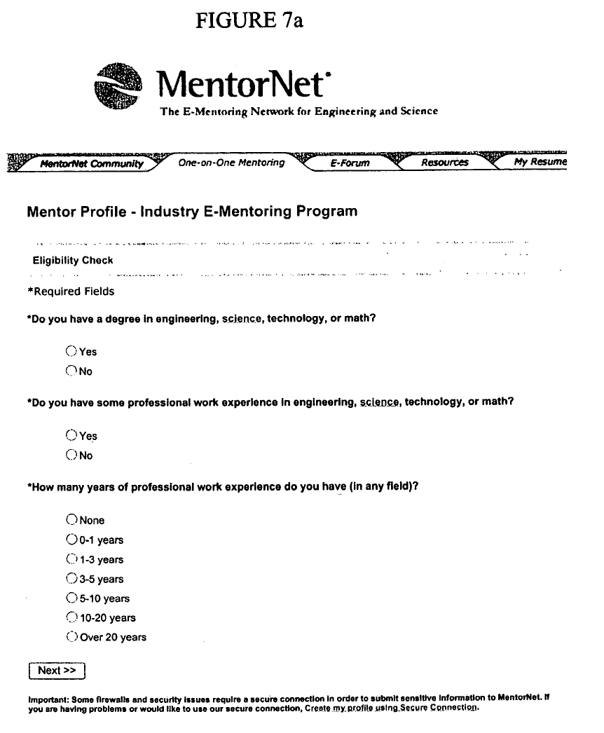

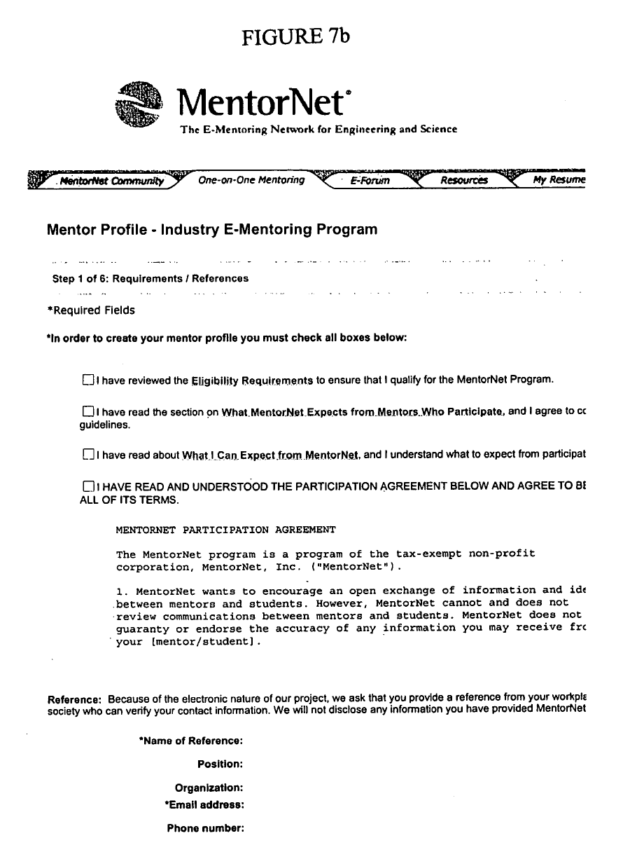

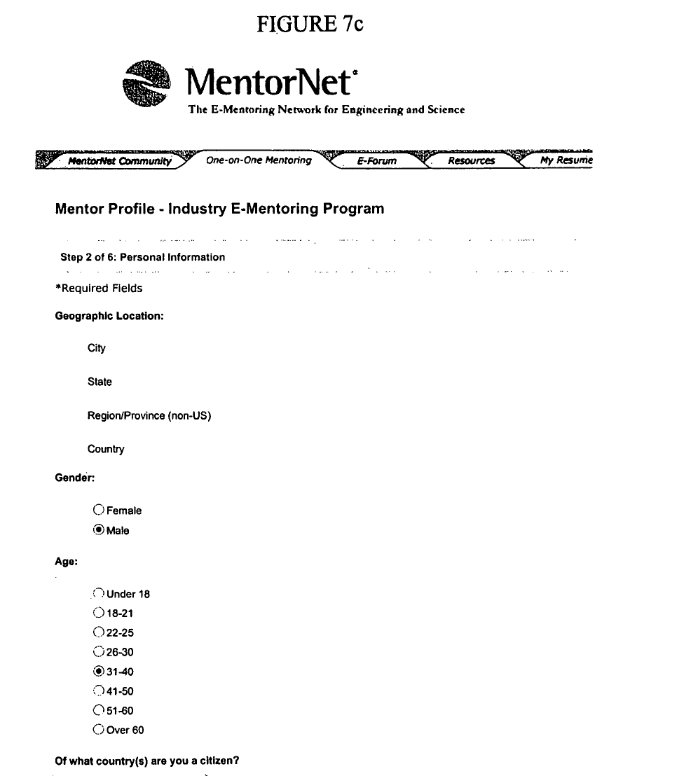

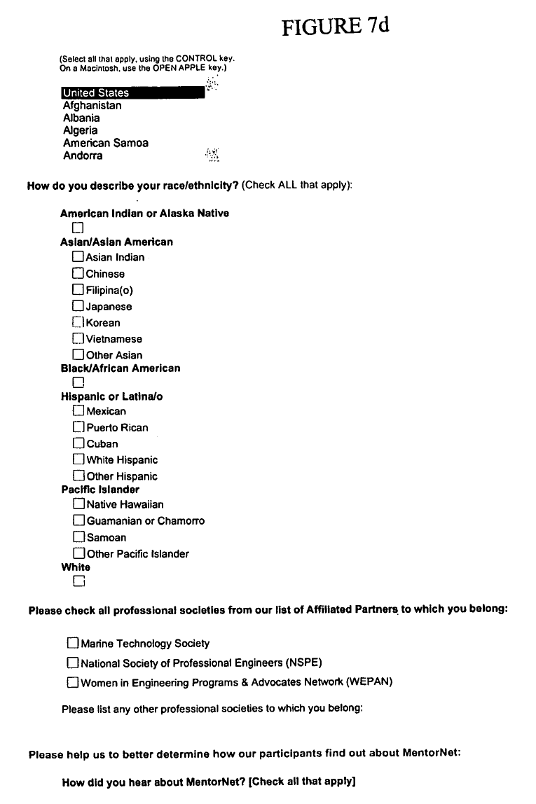

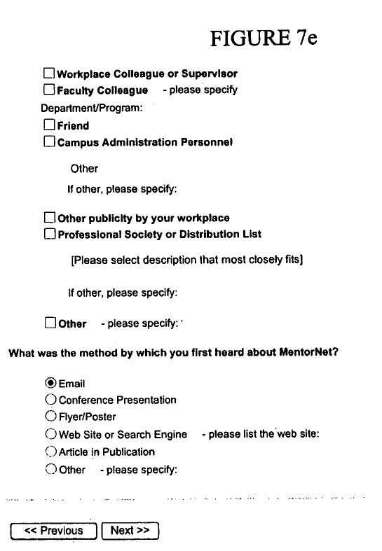

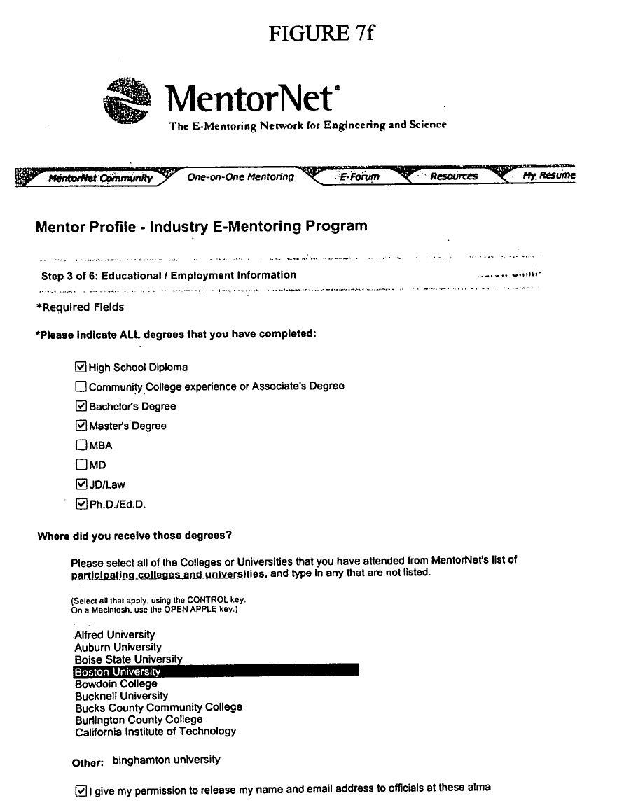

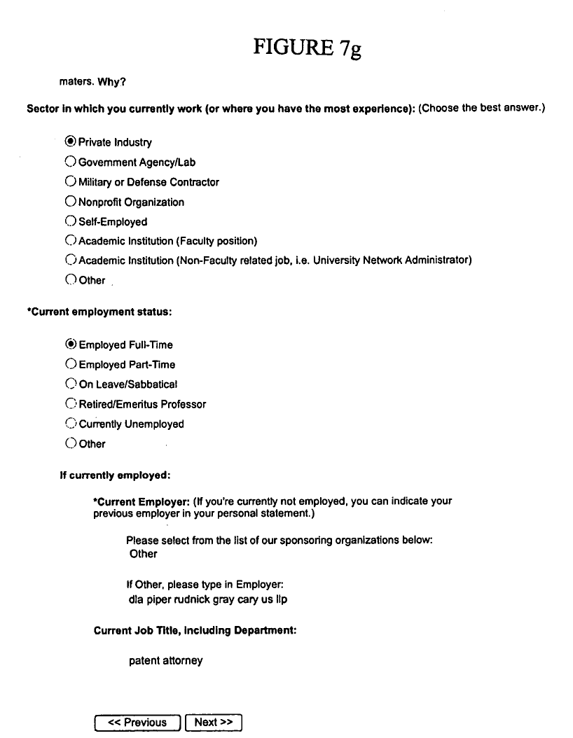

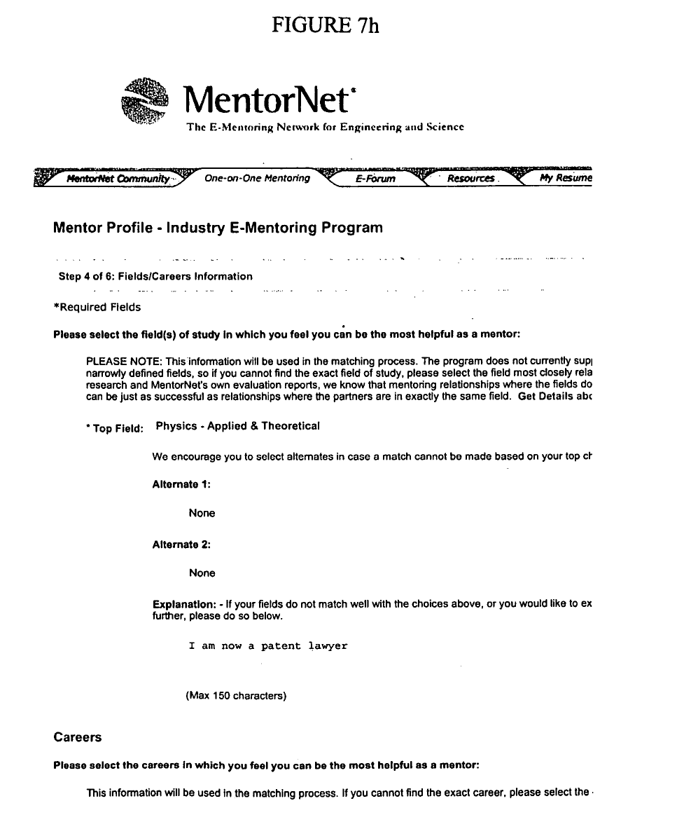

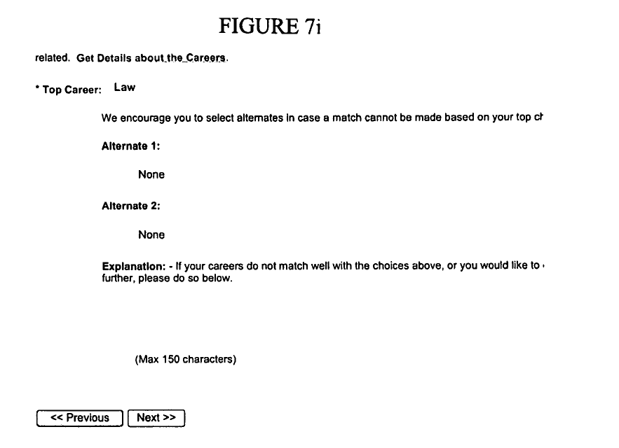

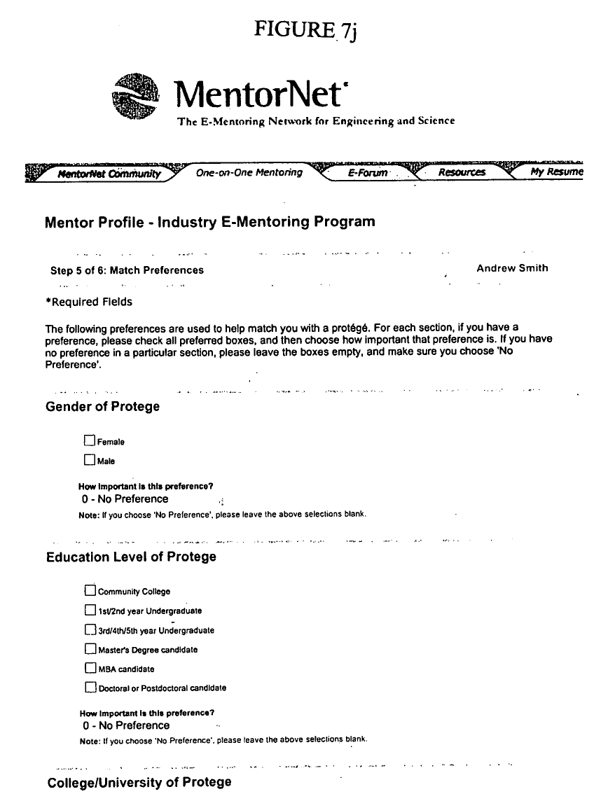

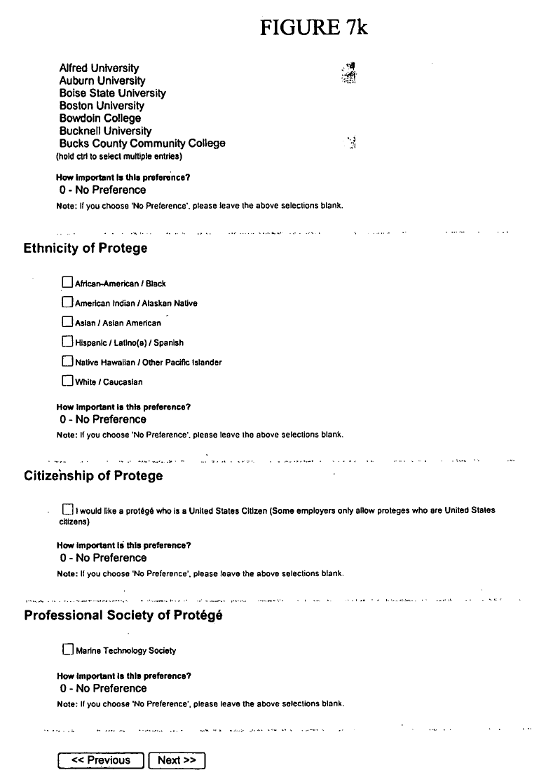

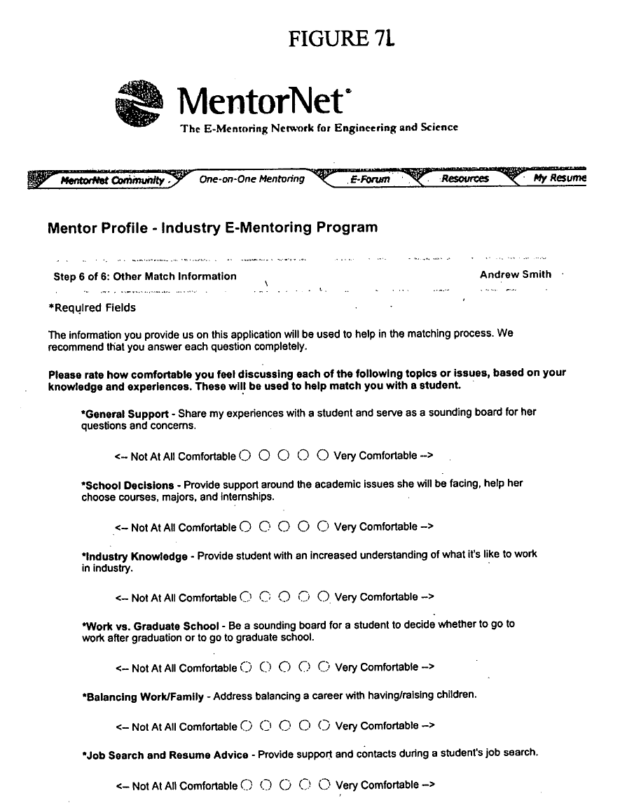

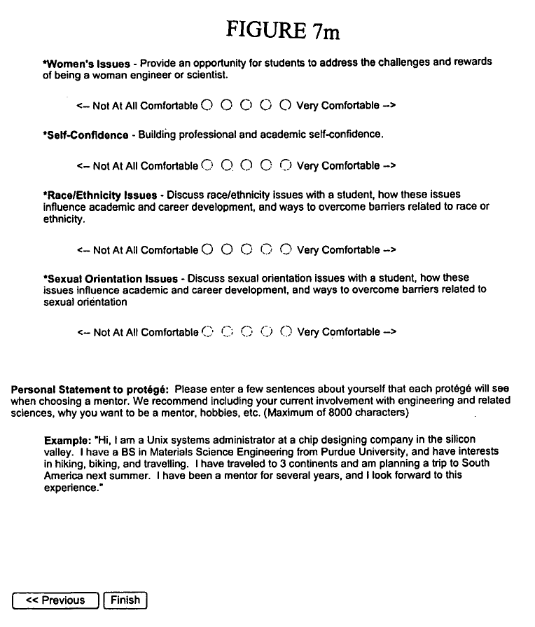

At 104 of FIG. 1, the system receives a protégé profile (see, e.g., FIGS. 6a-6m). At 106, the system receives a mentor profile (see, e.g., FIGS. 7a-7m). At 108, match scores are computed based on the protégé and mentor profiles. Note that both personal profiles and preferences are included in these protégé and mentor “profiles”. At 110, the set of possible matches is filtered down to a subset of one or more ‘best’ matches based on highest match scores. When more than one ‘best’ match score is provided, preferably an option is provided at 112 for selecting one of the matches.

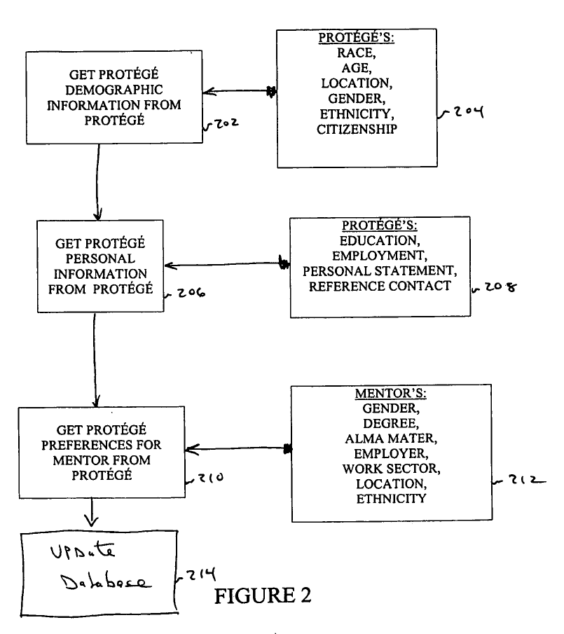

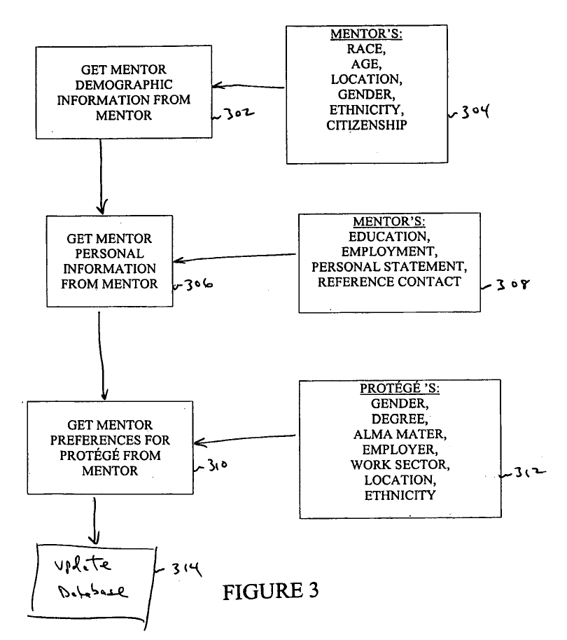

At FIG. 2, a process is illustrated in accordance with a preferred embodiment for creating a protégé profile that may be utilized in accordance with component 104 of FIG. 1. At 202, protégé demographic information is obtained, preferably as received from a protégé using the template illustrated at FIGS. 6a-6m (see below). Component 204 illustrates that demographic information may include race, age, location, gender, ethnicity, and/or citizenship. At 206, protégé personal information is obtained, again preferably as received from a protégé using the template illustrated at FIGS. 6a-6m (see below). Component 208 illustrates that personal information may include education, employment, a personal statement and/or a reference contact.

At 210, protégé match preferences regarding a potential mentor are obtained, again preferably as received from a protégé using the template illustrated at FIGS. 6a-6m (see below). The match preferences (Criteria) can be customized to fit selected mentoring programs, but for example, the match preferences (Criteria) may include: Gender of Mentor, Degree of Mentor, Alma Mater of Mentor, Employer of Mentor, Work Sector of Mentor, Geographic Location of Mentor, and Ethnicity of Mentor. The protégé preferably selects the importance of each of these preferences, using the scale: 0—No Preference, 1—Slight Preference, 2—Strong Preference, 3—Absolute Requirement. For each preference, if they choose anything other than ‘0—No Preference’, they are asked to check all checkboxes that agree with their preferences. For example, if they have a preference for Work Sector of Mentor, they might check ‘Private’, and ‘Nonprofit’. Component 212 illustrates that these preferences may include gender, degree, alma mater, employer, work sector, location and/or ethnicity. At 214, a database is updated (see FIG. 5).

Once the Protégé Profile is created, the protégé can click on a link to view a selected number, e.g., up to 5, recommended matches. These recommended matches are computed using a bi-directional matching algorithm that takes into account the protégé's match preferences, and each of the available mentors' match preferences, as well as other factors (described later), and determines the best matches (or another number) currently available for the protégé. If there are fewer than the selected number (e.g., 5) matches, it will show that amount. If there are no appropriate matches currently available, the web site will notify the protégé. In either case, the protégé has an opportunity to click on a link to go back to the screen where they can edit their match preferences and then view their recommended matches again.

Each mentor completes a ‘Mentor Profile’, which may include demographic information (age,gender,race/ethnicity,geographic location,citizenship), educational background ( . . . ), employment information ( . . . ), a personal statement, a reference contact, a rating (from 0-4) of 10 topics that a protégé might like to discuss, and their preferences for being matched with a protégé. At FIG. 3, a process is illustrated in accordance with a preferred embodiment for creating a mentor profile that may be utilized in accordance with component 106 of FIG. 1. At 302, mentor demographic information is obtained, preferably as received from a mentor using the template illustrated at FIGS. 7a-7m (see below). Component 304 illustrates that demographic information may include race, age, location, gender, ethnicity, and/or citizenship. At 306, mentor personal information is obtained, again preferably as received from a mentor using the template illustrated at FIGS. 7a-7m (see below). Component 308 illustrates that personal information may include education, employment, a personal statement and/or a reference contact.

At 310, mentor match preferences regarding a potential protégé are obtained, again preferably as received from a mentor using the template illustrated at FIGS. 7a-7m (see below). The match preferences can be customized to fit a selected mentoring program, For example, these match preferences may include: Gender of Protégé, Education Level of Protégé, College or University of Protégé, Ethnicity of Protégé, Citizenship of Protégé. The mentor may select the importance of each of these preferences, using the scale: 0—No Preference, 1—Slight Preference, 2—Strong Preference, 3—Absolute Requirement. For each preference, if they choose anything other than ‘0—No Preference’, they then check checkboxes that agree with their preferences. For example, if they have a preference for Education Level of Protégé, they might check ‘Bachelors 3rd,4th year’, and ‘Masters’. Component 312 illustrates that these preferences may include gender, degree, alma mater, employer, work sector, location and/or ethnicity. At 314, the database is updated (see FIG. 5).

Once this Mentor Profile is created, the mentor automatically becomes available to be matched with a protégé. At any time (as long as they are not currently matched), if the mentor wishes, he/she can temporarily make their profile inactive, or they can completely delete their profile by clicking on the appropriate link on the Mentor Profile page.

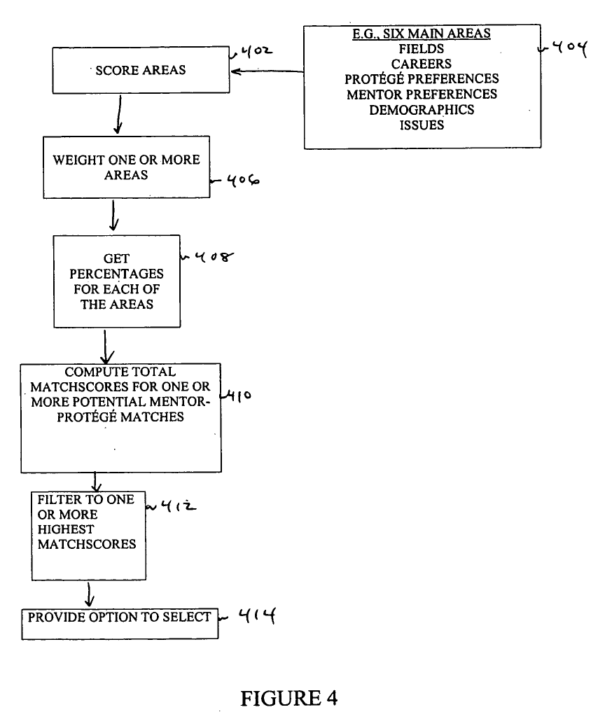

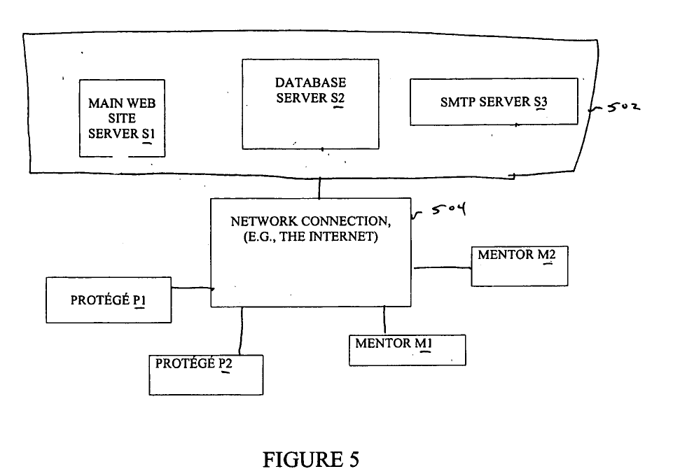

FIG. 4 illustrates a matching method in accordance with a preferred embodiment. At 402 multiple areas are scored. A ‘total possible score’ is preferably determined, based on the protégé's profile. This is the score that a match would receive if all of the areas matched perfectly. Component 404 illustrates that these areas may include six main areas: fields, careers, protégé preferences, mentor preferences, demographics and issues. These areas may be weighted, such that one or more of the areas has a larger contribution to the final selections than one or more other areas, as illustrated at component 406. At component 408, percentages are obtained for each of the areas. These percentages can have the weights calculated in, or the weights can be calculated in after the percentages are obtained. The total score is computed from the weighted area percentages to obtain MatchScores for one or more mentor-protégé matches at component 410. The potential matches are filtered to a selected number or according to a selected minimum score or other criteria at component 412. At 414, an option is provided to select one or the matches.

For each recommended match, the protégé is preferably shown profile information about each mentor. At this point, the protégé can make the decision to choose one of these mentors, or he/she can come back later and see if any new mentors have become available. Each protégé is given a selected number (e.g., 14) days from the date their Protégé Profile is created to choose a mentor (using a ‘DaysToSearch’ field in the database). If the protégé does not choose a mentor within the 14 days, they are automatically put into the ‘automatic matching pool’ (described later).

At any time during the 14 days that the protégé can select a mentor, the protégé can decide to immediately put themselves into the ‘automatic matching pool’ by clicking on a link from a main ‘View Recommended Matches’ page. At any time (as long as they are not currently matched), if the protégé wishes, he/she can temporarily make their profile inactive, or they can completely delete their profile by clicking on the appropriate link on the Protégé Profile page.

### Computer-Implemented Process/On-Line Environment

FIG. 5 illustrates a system in accordance with a preferred embodiment for executing a mentor-protégé matching method in accordance with a preferred embodiment. The system includes a host system 502 including a main web site housed on one server (S1), with a database server running on a different server (S2), and an SMTP server running on a third server (S3). The web site is comprised of dynamic web pages that interact with the database server S2 through a database network protocol. Specifically, the web server (S1) that is run by the company is compatible for use with Windows 2000 Server.TM, running .NET Framework.TM., but can be written in any language that is executable by any type of computer, and can be configured to be compatible for use with any type of operating system, software or Web browser. The database server S2 is running SQL Server 2000.TM., but any scalable relational database system that can communicate with the web server and operating system can be used. The end users (mentors M1, M2 and protégés P1, P2) can access the web site through any client web browser capable of reading web pages via a network connection 504 such as the internet. This can be done from any remote location that has web access.

Exemplary display template pages are illustrated at FIGS. 6a through 6m for collecting information from a potential protégé to get his or her profile and preferences. FIGS. 6a-6b illustrate an eligibility check. If a potential protégé is not eligible (e.g., because he or she is not a student or postdoc at one of MentorNet's participating campuses, or a member of one of a selected numbers of professional societies, or more generally fails to meet one or more different or additional selectively predetermined criteria), then the process will not proceed to the next step. FIGS. 6c-6e illustrate several fields for the potential protégé (hereinafter simply protégé) for obtaining mostly demographic information. FIGS. 6f-6g illustrate pages wherein protégés input preferences regarding fields of experience or study of potential mentors. FIGS. 6h-6k illustrates pages wherein a protégé inputs demographic preferences relating to preferred mentors. FIGS. 6l-6m illustrate further preferences pages for protégés to input information relating to preferred mentors that include one or more scales for weighting whether the protégé wishes that his or her mentor have certain qualities or other issues.

Exemplary display template pages are illustrated at FIG. 7a through 7m for collecting information from a potential mentor to get his or her profile and preferences. FIGS. 7a-7b illustrate an eligibility check. If a potential mentor is not eligible because he or she does not have an appropriate degree or work experience, then the process will not proceed to the next step. FIGS. 7c-7e illustrate several fields for the potential mentor (hereinafter simply mentor) for obtaining mostly demographic information. FIGS. 7f-7g illustrate pages wherein mentors input information regarding degrees and schools they have attended. FIGS. 7h-7i illustrate pages wherein a mentor inputs preferences regarding protégés that they may mentor. For example, the field and/or career choices of protégés are input as being areas that the mentor feels that he or she may be most helpful. FIGS. 7j-7k illustrate pages wherein a mentor inputs demographic preferences for protégés that they may mentor. FIGS. 7l-7m illustrate further preferences pages for mentors to input information relating to preferred protégés that include one or more scales for weighting whether the mentor wishes that his or her protégé have certain qualities or other issues.

### Bidirectional Matching Algorithm

When a protégé clicks on the link to view their recommended matches, the following algorithm is run. This software-based matching process is computer-implemented preferably according to the system illustrated at FIG. 5, and the processes and/or components briefly illustrated above with reference to FIGS. 1-4.

A stored procedure is called from the database which returns a set of mentors that are available to be matched, and that match with at least one the current protégé's chosen fields. The number of potential mentors returned that match with at least one of the current protégé's fields will determine FieldWeight and the FieldMin (described below). For instance, if there are less than 20 mentors available in the current protégé's fields, the process sets the FieldWeight and the FieldMin to lower values, to allow for greater potential of finding matches. So, now there is a dataset containing information about each mentor. The process loops through each of these mentors and calls GetMatchScore (described below), which returns the ‘Score’ for each potential match. If this match is a ‘PossibleMatch’, then this potential match is added into the PotentialMatches datatable. A match may be a PossibleMatch if the score is above a threshold score or if the score is the top score or in the top three or top five or another criteria.

Once all of the possible matches have been added to the PotentialMatches datatable, there may be many potential matches. In a preferred embodiment, the system is set to return only the ‘best’ 5. If the customized program is determined not to give priority to certain mentors, then this process can be completed by returning the top 5 MatchScores as the recommended matches. For the current program, however, the final recommended matches are preferably calculated the following way:

Start off with a MinimumMatchScore=84. Taking all of the potential matches found in the PotentialMatches datatable, determine how many have a MatchScore greater than the MinimumMatchScore. If there are less than 5 matches found (greater than the MinimumMatchScore), drop the MinumumMatchScore by 5, and determine the count again. Keep dropping by 5 until there are at least 5 found, or until the MinimumMatchScore=50.

Once at least 5 matches are found, the group is preferably narrowed down to 5, such that only 5 matches are recommended to each protégé. This group is sorted by whatever priorities are determined and/or selected. For example, mentors who are employed by sponsoring companies may get priority, and mentors that have participated in previous years may get priority. Once this group is sorted, the top 5 results are returned.

### Getmatchscore Algorithm

To calculate each MatchScore, there are 6 main areas that receive a score (Fields, Careers, Student Preferences, Mentor Preferences, Demographics, Issues). Each of these areas are given a weight. These weights can be adjusted in order to customize the matching algorithm based on what is most important, least important, etc. to the match. Each area is explained below:

### Fields

The fields (TopField, Alt1Field, Alt2Field) chosen by the protégé are compared with those chosen by the mentor. A percentage is returned based on how closely these choices match. This percentage is multiplied by the FieldWeight to produce the final ‘FieldScore’. If this FieldScore is less than the FieldMin (set earlier), this potential match is no longer a PossibleMatch, and we move on to the next potential mentor. If it is still a PossibleMatch, the score is added to the CurrentScore (which is initially set to zero).

### Careers

The careers (TopCareer, Alt1Career, Alt2Career) chosen by the protégé are compared with those chosen by the mentor. A percentage is returned based on how closely these choices match. This percentage is multiplied by the CareerWeight to produce the final ‘CareerScore’. This score is added to the CurrentScore.

### Student Preferences

Before the current protégé iterates through each potential mentor, a PotentialPrefScore is calculated by adding up all of the match preference values from her/his Protégé Profile. If this PotentialPrefScore is zero (no match preferences), this protégé automatically gets the full StudentPrefsWeight for each mentor. Otherwise, loop through each Match Preference (Criteria). If the protégé has a preference for the current criterion, check to see if their preference is met with the current mentor. If it is, add the value of the preference (1,3,5) to the StudentPrefScore. If the preference is not met, AND the value of the preference is 5 (Absolute Requirement), this is NOT a PossibleMatch, and move on to the next potential mentor. If after looping through each criterion this is still a PossibleMatch, the final StudentPrefScore is achieved by the following: (StudentPrefScore/PotentialPrefScore) * StudentPrefsWeight.

### Mentor Preferences

Before the current mentor is evaluated, a PotentialMentorPrefScore is calculated by adding up all of the match preference values from her/his Mentor Profile. If this PotentialMentorPrefScore is zero (no match preferences), the final MentorPrefScore gets the full MentorPrefsWeight. Otherwise, loop through each Match Preference (Criteria). If the mentor has a preference for the current criterion, check to see if their preference is met with the current protege. If it is, add the value of the preference (1,3,5) to the MentorPrefScore. If the preference is not met, AND the value of the preference is 5 (Absolute Requirement), this is NOT a PossibleMatch, and move on to the next potential mentor. If after looping through each criterion this is still a PossibleMatch, the final MentorPrefScore is achieved by the following: (MentorPrefScore/PotentialMentorPrefScore) * MentorPrefsWeight.

### Demographics

For the current program, the important demographic information is comprised of Age, Degrees, Years Work Experience, and Community College Experience. These can be customized for various programs. Each of these sections is described below:

### Age

The mentors and protégés were asked to select their age range. If the mentor's age range is higher (older) than the protégé, the full score is given for this section (DemogWeight/4, since there are 4 parts to the Demographics). If the protégé's range is higher (older) than the mentor, no score is added. And if they both are in the same range, half of the possible score is added.

### Degrees

If the mentor currently has a degree that is equal to or more advanced than the degree that the protégé is currently obtaining, the full score is given for this section. Otherwise, no score is added.

### Years Work Experience

The mentors and protégés were asked to select the range of years of work experience (YearsExp). If the mentor's range is greater than the protégé, the full score is given for this section. If the protégé's range is greater than the mentor, no score is added. And if they both are in the same range, half of the possible score is added.

### Community College Experience

If the protégé is currently attending a Community College, and the mentor has some Community College experience, the full score is added. If the protégé is NOT currently attending a Community College, the full score is automatically added.

### Issues

These are the 10 topics that each protégé and mentor rated from 0-4. To calculate the IssueScore, start off with IssueCount=0. Loop through all 10 topics, and if the mentor's rating is ‘close enough’ to the protégé's rating, add 1 to IssueCount. For the current program, it is considered ‘close enough’ if the mentor's rating minus the protégé's rating is greater than −1. But if the protégé's rating is at least 3 more than the mentor's, the match automatically is no longer a PossibleMatch, and we go on to the next mentor. Once all 10 topics are scored, the final IssueScore is taken by multiplying the IssueWeight * (IssueCount/10)

Once all of these areas are evaluated, if this potential match is still a PossibleMatch, the final score is returned, and this match will be added as a potential match. Once a week, a batch program runs that takes all of the protégés in the ‘Automatic Matching Pool’, and attempts to find matches for them. The ‘Automatic Matching Pool’ includes all protégés who still have an ‘active’ Protégé Profile, and DaysToSearch=0. This program can be written in any programming language that can interact with the database. The current program is written in VB.Net, and compiled into an executable that is run as a weekly batch job. The algorithm is described below.

### Automatic Matching Pool Algorithm

This algorithm is run several different times, using different variables for MinMatchScore and DegreeToUse, in order to maximize the matching pool available.

Set the minimum match score (MinMatchScore)

Set the protégé degree to use (DegreeToUse)

Get the pool of active protégés with DaysToSearch=0, and with a degree=‘DegreeToUse’. (Running this algorithm by degree helps to find mentors with higher degrees (Masters,PHD) for protégés with higher degrees.)

Loop through each protégé in this pool. For each protégé, get the match score with each potential mentor using the GetMatchScore Algorithm described above. If the match score for this potential match is at least the MinMatchScore, call a stored procedure which writes this potential match into a table (GoodMatches), including MentorID, ProtegeID, MatchScore, StrongPrefsWrong.

Once all of the protégés have been checked with all of the mentors, all of the potential matches should be in the GoodMatches table. Since there could be multiple potential matches for each protégé, as well as multiple matches for each mentor, we must run an algorithm that determines the final matches.

### Determining Final Matches Algorithm

In the current program, this algorithm is written as a set of stored procedures.

### Findoneprotegematches

Find all potential matches in the GoodMatches table where a protege only matches with one mentor. For each of these matches, write this match into another table (FinalMatches). Once this is done, delete all of the potential matches in the GoodMatches table that are connected with any of the mentors or protégés in the FinalMatches table. Now repeat this process until no matches are added to the FinalMatches table.

### Findonementormatches

Find all potential matches in the GoodMatches table where a mentor only matches with one protege. For each of these matches, write this match into another table (FinalMatches). Once this is done, delete all of the potential matches in the GoodMatches table that are connected with any of the mentors or protégés in the FinalMatches table. Now continue to call ‘FindOneProtegeMatches’, and then FindOneMentorMatches until no matches are added to the FinalMatches table.

### Findmultiplematches

Count the number of distinct protégés left in the GoodMatches table. Set a variable (TotalToMatch) to ¼ of this number. (If the number of protégés left is less than 4, set TotalToMatch equal to this number.) Loop through each distinct protege, in ascending order, starting with the protégés that match with the fewest number of mentors. For each protégé, find the potential mentor that has the fewest StrongPrefsWrong, and then the highest MatchScore, and write this match into the FinalMatches table. Continue this until there have been TotalToMatch records written to FinalMatches. Now go back to the top and repeat the entire process again until there are no matches left in the GoodMatches table.

Once there are no more matches left in the GoodMatches table, all of the new matches are in the FinalMatches table. These need to be written into the ‘live’ MatchInfo table. Loop through each match in the FinalMatches table, write the record into the MatchInfo table with a ‘status’=‘1—Pending’, send an email to the mentor to confirm their availability, and set the Mentor and Protégé Profile status to ‘inactive’. Once this loop is completed, delete the records from the FinalMatches table.

Once a match is made (either by a student selecting a mentor, or by the automatic process), that information is written into a Match Table in the database, with a match ‘status’ of ‘1—Pending’. At the same time, an email is automatically sent to the potential mentor of this match, asking them to confirm their availability. In order for them to do this, they must go to the main web site and sign in using their UserName and Password. Once they sign in, the system knows that this user has a ‘pending’ match, so it immediately shows them a link to click on to get to the ‘Confirm Availability’ page. From this ‘Confirm Availability’ page, the mentor must select one of two choices: 1. Yes, I am ready to begin my relationship, or 2. No, I am not interested in being a mentor at this time.

If the user chooses #2, they must select the reason they are not interested at this time. These reasons can be customized, and in the current project they are supplied in an xml file. Once they select a reason and submit the form, the match ‘status’ is changed from ‘1—Pending’ to ‘2—Declined’. If the protégé had selected this mentor, an email would be sent out at this time to the protégé, letting them know that the mentor they had chosen is currently unavailable. The ‘DaysToSearch’ field is reset to 14 for this protégé, giving them time to search for another mentor if they wish.

If the mentor chooses #1, the match ‘status’ is changed from ‘1—Pending’ to ‘4—Matched’, and the ‘MatchStartDate’ field is set to the next business day. The ‘MatchEndDate’ is set to 8 months after the MatchStartDate. The current program duration is 8 months, but this can be easily customized. Once this match is made, the protége's Profile is set to ‘Inactive’, meaning they cannot be matched with another mentor. Also, the mentor's Profile is set to ‘Inactive’, meaning they are not available to be matched with an additional protégé. If the mentor wishes, they can ‘reactivate’ their Mentor Profile, making themselves available for additional protégés. While an exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the appended claims and structural and functional equivalents thereof. For example, features may be added such as Coaching Prompts, Administration/setup of prompts, Automated Batch Stored Procedures, Facilitation, Surveys, reminders, Partners Community and/or Sponsor Renewal System, which may be each found at www.mentornet.net, which is hereby incorporated by reference.

In addition, in methods that may be performed according to preferred embodiments herein and that may have been described above, the operations have been described in selected typographical sequences. However, the sequences have been selected and so ordered for typographical convenience and are not intended to imply any particular order for performing the operations, except for those where a particular order may be expressly set forth or where those of ordinary skill in the art may deem a particular order to be necessary.

That which is described as background and the invention summary are hereby incorporated by reference into the detailed description of the preferred embodiments, as disclosing alternative embodiments of elements or features of the preferred embodiments not otherwise set forth in detail in there.

What is claimed is:

1. A computer-implemented method for bi-directionally matching a protégé and a mentor among participants in an online environment, comprising:
(a) registering participants for identification within the online environment;
(b) receiving at least one mentor profile including demographic or personal information, or both, about the mentor, as well as the mentor's preferences regarding potential protégés;
(c) receiving at least one protégé profile including demographic or personal information, or both, about the protégé, as well as the protégé's preferences regarding potential mentors;
(d) bi-directionally calculating one or more recommended mentor-protégé matches based on the mentor and protégé profile information and preferences; and
(e) outputting results.

2. The method of claim 1, wherein the bi-directional calculating comprises comparing information and preferences of multiple pairs of mentor-protégé profiles.

3. The method of claim 2, wherein the bi-directional calculating further comprises:
(i) computing a percentage for each area based on how closely the areas match;
(ii) summing to obtain a total match score; and
(iii) determining that the total match score is above a predetermined match score.

4. The method of claim 3, wherein the bi-directional calculating further comprises:
(iv) setting a weight to one or more information or preferences areas within the mentor or protégé profiles, or combinations thereof; and
(v) multiplying the percentage by the weight provided to each area.

5. The method of claim 1, wherein demographic information includes age, location, gender, race/ethnicity or citizenship, or combinations thereof.

6. The method of claim 1, wherein the personal information includes education, employment, a personal statement or a reference contact, or combinations thereof.

7. The method of claim 1, wherein the preferences include gender, degree, alma mater, employer, work sector, location or ethnicity, or combinations thereof.

8. The method of claim 1, further comprising sending one or more coaching prompts to one or more matched participants.

9. The method of claim 1, wherein the results comprise multiple candidate matches, and the method further comprises receiving a match selection from a participant out of the multiple candidate matches.

10. A computer-implemented method for managing a relationship between a protégé and a mentor among participants in an online environment, comprising:
(a) registering participants for identification within the online environment;
(b) receiving participant profiles including demographic or personal information about the participants, or the participant's preferences regarding potential matches, or combinations thereof;
(c) computing one or more recommended mentor-protégé matches based on the mentor and protégé profiles;
(d) outputting results;
(e) selecting a pair of matched participants from the results; and
(f) sending one or more coaching prompts to one or more matched participants.

11. The method of claim 10, wherein the computing comprises comparing information of multiple pairs of mentor-protégé profiles.

12. The method of claim 10, wherein the results comprise multiple candidate matches, and the selecting comprises receiving a match selection from a participant out of the multiple candidate matches.

13. The method of claim 10, further comprising sending a relationship evaluation request to one or more participants.

14. A server-based computer system for bi-directionally matching a protégé and a mentor among participants in an online environment, comprising:
(a) a main web site server for registering participants, from one or more remote client computers connected to the server by a network connection, for identification within the online environment;
(b) a database server for receiving a mentor profile from a second remote client computer also connected to the server by a network connection, including demographic or personal information, or both, about the mentor, as well as the mentor's preferences regarding potential protégés, and for receiving a protégé profile from the first or a third network-connected remote client computer including demographic or personal information, or both, about the protégé, as well as the protégé's preferences regarding potential mentors; and
(c) one or more processors for bi-directionally calculating one or more recommended mentor-protégé matches based on the mentor and protégé profile information and preferences, and outputting results.

15. The system of claim 14, wherein the bi-directional calculating comprises comparing information and preferences of multiple pairs of mentor-protégé profiles.

16. The system of claim 15, wherein the bi-directional calculating further comprises:
(i) computing a percentage for each area based on how closely the areas match;
(ii) summing to obtain a total match score; and
(iii) determining that the total match score is above a predetermined match score.

17. The system of claim 16, wherein the bi-directional calculating further comprises:
(iv) setting a weight to one or more information or preferences areas within the mentor or protégé profiles, or combinations thereof; and
(v) multiplying the percentage by the weight provided to each area.

18. The system of claim 14, wherein demographic information includes race, age, location, gender, ethnicity or citizenship, or combinations thereof.

19. The system of claim 14, wherein the personal information includes education, employment, a personal statement or a reference contact, or combinations thereof.

20. The system of claim 14, wherein the preferences include gender, degree, alma mater, employer, work sector, location or ethnicity, or combinations thereof.

21. The system of claim 14, further comprising an email server for sending one or more coaching prompts to the mentor or protégé, or both.

22. The system of claim 14, wherein the results comprise multiple candidate matches and are configured to permit a participant to select a match.

23. A server-based computer system for managing a relationship between a protégé and a mentor among participants in an online environment, comprising:
(a) a main web site server for registering participants, from one or more remote client computers connected to the server by a network connection, for identification within the online environment;
(b) a database server for receiving participant profiles also from remote client computers connected to the server by a network connection, including demographic or personal information about the participants, or the participant's preferences regarding potential matches;
(c) one or more processors for computing one or more recommended mentor-protégé matches based on the profile information, and outputting results from which matched participants are selected; and
(d) an email server for sending one or more coaching prompts to one or more of the matched participants.

24. The system of claim 23, wherein the computing comprises comparing information of multiple pairs of mentor-protégé profiles.

25. The system of claim 23, wherein the results comprise multiple candidate matches and are configured to permit a participant to select a match.

26. The system of claim 23, wherein the email server further for sending a relationship evaluation request to one or more participants.

27. One or more processor readable storage devices having processor readable code embodied thereon, said processor readable code for programming one or more processors to perform a method of bi-directionally matching a protégé and a mentor among participants in an online environment, the method comprising:
(a) registering participants for identification within the online environment;
(b) receiving a mentor profile including demographic or personal information, or both, about the mentor, as well as the mentor's preferences regarding potential protégés;
(c) receiving a protégé profile including demographic or personal information, or both, about the protégé, as well as the protégé's preferences regarding potential mentors;
(d) bi-directionally calculating one or more recommended mentor-protégé matches based on the mentor and protégé profile information and preferences; and
(e) outputting results.

28. The one or more storage devices of claim 27, wherein the bi-directional calculating comprises comparing information and preferences of multiple pairs of mentor-protégé profiles.

29. The one or more storage devices of claim 28, wherein the bi-directional calculating further comprises:
(i) computing a percentage for each area based on how closely the areas match;
(ii) summing to obtain a total match score; and
(iii) determining that the total match score is above a predetermined match score.

30. The one or more storage devices of claim 29, wherein the bidirectional calculating further comprises:
(iv) setting a weight to one or more information or preferences areas within the mentor or protégé profiles, or combinations thereof; and
(v) multiplying the percentage by the weight provided to each area.

31. The one or more storage devices of claim 27, wherein demographic information includes race, age, location, gender, ethnicity or citizenship, or combinations thereof.

32. The one or more storage devices of claim 27, wherein the personal information includes education, employment, a personal statement or a reference contact, or combinations thereof.

33. The one or more storage device of claim 27, wherein the preferences include gender, degree, alma mater, employer, work sector, location or ethnicity, or combinations thereof.

34. The one or more storage devices of claim 27, wherein the method further comprises sending one or more coaching prompts to the mentor or protégé, or both.

35. The one or more storage devices of claim 27, wherein the results comprise multiple candidate matches, and the method further comprises receiving a match selection from a participant out of the multiple candidate matches.

36. One or more processor readable storage devices having processor readable code embodied thereon, said processor readable code for programming one or more processors to perform a method of managing a relationship between a protégé and a mentor among participants in an online environment, the method comprising:
(a) registering participants for identification within the online environment;
(b) receiving participant profiles including demographic or personal information about the participants, or the participant's preferences regarding potential matches, or combinations thereof;
(c) computing one or more recommended mentor-protégé matches based on the mentor and protégé profiles;
(d) outputting results;
(e) selecting a pair of matched participants from the results; and
(f) sending one or more coaching prompts to one or more matched participants.

37. The one or more storage devices of claim 36, wherein the computing comprises comparing information of multiple pairs of mentor-protégé profiles.

38. The one or more storage devices of claim 36, wherein the results comprise multiple candidate matches, and the selecting comprises receiving a match selection from a participant out of the multiple candidate matches.

39. The one or more storage devices of claim 36, wherein the method further comprises sending a relationship evaluation request to one or more participants.
